(19) United States
(12) Patent Application Publication
(10) Pub. No.: US 2015/0009518 A1
(43) Pub. Date: Jan. 8, 2015

(54) MAGE READING APPARATUS, METHOD OF CONTROLLING IMAGE READING APPARATUS, AND STORAGE MEDIUM

(71) Applicant: CANON KABUSHIKI KAISHA, Tokyo (JP)

(72) Inventor: Masaki Kashiwagi, Hiratsuka-shi (JP)

(21) Appl. No.: 14/321,625

(22) Filed: Jul. 1, 2014

(30) Foreign Application Priority Data
Jul. 3, 2013 (JP) 2013-139778

(51) Int. Cl. H04N 1/00

(52) U.S. Cl. CPC H04N 1/00896; H04N 1/00708; H04N 1/00405
USPC 358/1.13

(57) ABSTRACT

An image reading apparatus, easily determines the size of the document after the start of the device even if the size of a document cannot be determined during the start of a device.

### BACKGROUND

1. Field

Aspects of the present invention generally relate to an image reading apparatus that returns from a power saving state by opening and closing of a document cover, a method of controlling the image reading apparatus, and a storage medium.

2. Description of the Related Art

Conventionally, there is an image reading apparatus that, if a certain time period has elapsed without receiving an operation from a user, transitions to a power saving state, where the supply of power to units such as a printer controller and a scanner controller is cut off.

After the transition to the power saving state, if a return trigger for returning from the power saving state is generated, such an image reading apparatus returns from the power saving state. Examples of the return trigger include the reception of a return request from the user through an operation unit and the opening and closing of a document cover.

Various sensors detect the return trigger for returning from the power saving state. If the return trigger has been detected, each sensor sends an interrupt signal to a power control unit. If the interrupt signal has been received, the power control unit starts supplying power to the units.

Further, a conventional image reading apparatus detects the size of a document placed on a document platen, by irradiating the document with light when a document cover is closed, and reading the reflected light from the document irradiated with the light, using a sensor (see Japanese Patent Application Laid-Open No. 2010-130631). This detection of the size of the document is performed when the opening angle of the document cover is small.

The reason why the size of the document is detected when the opening angle of the document cover is small is to irradiate the document with light in the state where outside light enters with difficulty, and then detect the size of the document from the reflected light from the document, thereby accurately determining the size of the document.

Further, this detection of the size of the document cannot be performed with the document cover closed. This is because a reference plate for holding down the document is formed of a white member so that the portion other than the document is not colored when an image of the document is read, and therefore, if the document cover is closed, it is difficult to distinguish the boundary between the document and the reference plate. That is, the conventional image reading apparatus determines the size of the document under a situation where a larger amount of reflected light returns from the document while a smaller amount of reflected light returns from other portions because the document is not present, in the course of closing the document cover.

In the conventional art, however, a certain time period is required from the opening and closing of the document cover to the completion of the start of the image reading apparatus. During this time, the image reading apparatus is not started, and therefore, it is not possible to irradiate the document with light or perform a reading process for reading the reflected light from the document, to determine the size of the document placed on the document platen. Thus, if the document cover is closed before the start of the image reading apparatus is completed, the image reading apparatus cannot determine the size of the document placed on the document platen. If the size of the document cannot be determined, it is not possible to determine the size of a print sheet. Consequently, an image of the document may be copied on a print sheet of a size that is not intended by the user.

### SUMMARY OF THE INVENTION

According to an aspect of the present invention, an image reading apparatus having a first power state and a second power state where power consumption is less than in the first power state includes a document cover configured to be opened and closed to place a document on a document platen, a determination unit configured to, based on opening and closing of the document cover, determine a size of the document placed on the document platen, a power control unit configured to cause the image reading apparatus to transition from the second power state to the first power state, and a notification unit configured to, if the determination unit has not determined the size of the document placed on the document platen after the power control unit has caused the image reading apparatus to transition from the second power state to the first power state, prompt opening and closing of the document cover.

Further features of the present disclosure will become apparent from the following description of exemplary embodiments with reference to the attached drawings.

### BRIEF DESCRIPTION OF THE DRAWINGS

FIG. 1 is a block diagram illustrating the configuration of an image forming system according to the present exemplary embodiment.

FIG. 2 is a cross-sectional view illustrating the configuration of an image forming apparatus according to the present exemplary embodiment.

FIG. 3 is an external view illustrating an operation unit according to the present exemplary embodiment.

FIG. 4 is an external view illustrating a document platen according to the present exemplary embodiment.

FIGS. 5A and 5B are a cross-sectional view and a perspective view illustrating the process of detecting the size of a document, according to the present exemplary embodiment.

FIG. 6 is a flow chart illustrating an example of control according to the present exemplary embodiment.

FIG. 7 is a flow chart illustrating an example of control according to the present exemplary embodiment.

FIG. 8 is a flow chart illustrating an example of control according to the present exemplary embodiment.

FIG. 9 is a flow chart illustrating an example of control according to the present exemplary embodiment.

FIG. 10 is a diagram illustrating an example of the display of an operation screen according to the present exemplary embodiment.

FIG. 11 is a diagram illustrating an example of the display of an operation screen according to the present exemplary embodiment.

FIG. 12 is a flow chart illustrating an example of control according to the present exemplary embodiment.

FIG. 13 is a diagram illustrating an example of the display of an operation screen according to the present exemplary embodiment.

FIG. 14 is a flow chart illustrating an example of control according to the present exemplary embodiment.

FIG. 15 is a diagram illustrating an example of the display of an operation screen according to the present exemplary embodiment.

### DESCRIPTION OF THE EMBODIMENTS

Various exemplary embodiments will be described in detail below with reference to the drawings.

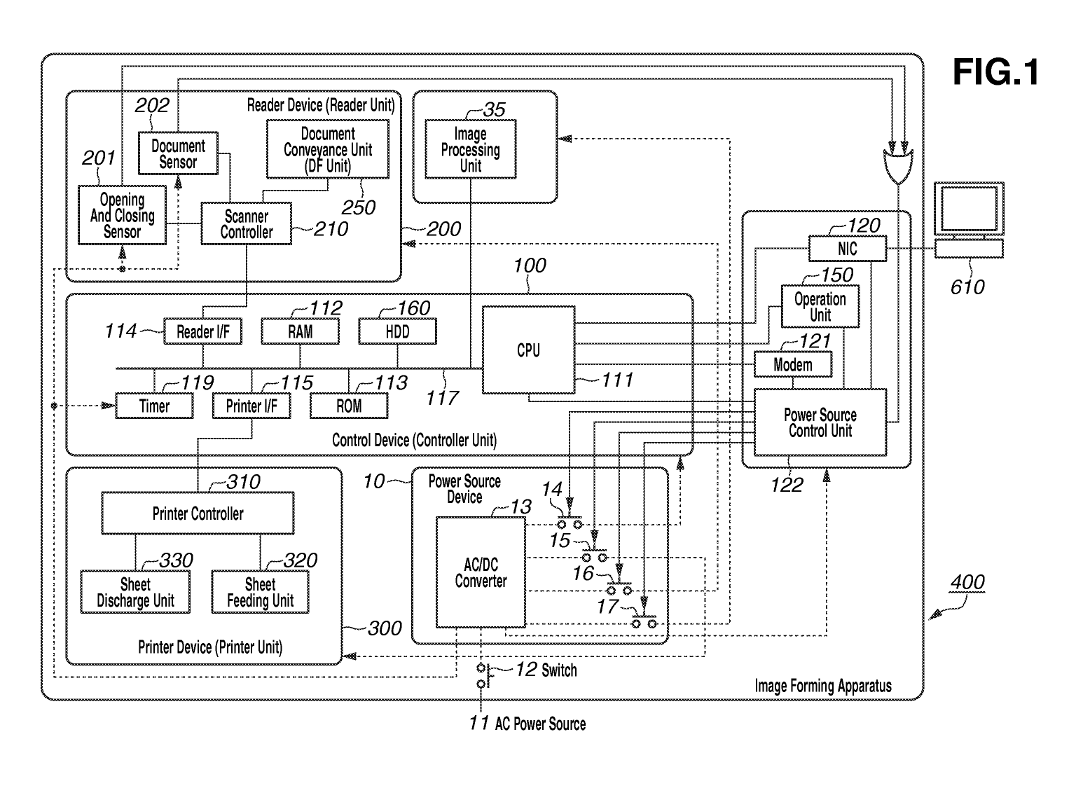

FIG. 1 is a block diagram illustrating the configuration of an image forming system according to a first exemplary embodiment. The image forming system includes an image forming apparatus 400, which is an example of an image reading apparatus, and a host computer 610. The image forming apparatus 400 and the host computer 610 are connected together via a local area network (LAN) such as Ethernet (registered trademark).

The image forming apparatus 400 includes a control device (controller unit) 100, which functions as a main control unit of the image forming apparatus 400. Further, the image forming apparatus 400 includes a reader device (reader unit) 200, which reads an image of a document to generate image data, and a printer device (printer unit) 300, which performs printing based on image data. Further, the image forming apparatus 400 includes an image processing unit 35, which processes image data, and a power source device 10, which converts power supplied from an alternating current (AC) power source (mains electricity) 11 from alternating current to direct current and supplies the converted power to the devices.

Further, the image forming apparatus 400 includes an operation unit 150, which includes a keyboard for receiving an input from a user and a liquid crystal panel for displaying an operation screen and receiving an operation from the user through a touch panel.

The image forming apparatus 400 communicates with the computer 610 on a wired network such as a LAN or a wireless network such as Wi-Fi via a network interface card (NIC) 120. Although an NIC has been described here, the image forming apparatus 400 may be connected to the computer 610 through a local interface such as a Universal Serial Bus (USB) interface. Further, the image forming apparatus 400 communicates with an external facsimile apparatus via a modem 121 and a telephone circuit. The modem 121 includes a network control unit (NCU) for controlling communication with a facsimile apparatus, and a modulation/demodulation circuit.

The control device (controller unit) 100 includes a central processing unit (CPU) 111, a random-access memory (RAM) 112, a read-only memory (ROM) 113, a reader interface (I/F) 114, a printer I/F 115, and a hard disk drive (HDD) 160.

The CPU 111 reads a program stored in the ROM 113 or the HDD 160 into the RAM 112 and executes the program, thereby performing overall control of the image forming apparatus 400.

The RAM 112 functions as a work area for the CPU 111. The ROM 113 stores various programs to be read by the CPU 111.

The reader I/F 114 controls the data communication between the control device 100 and the reader device 200. The printer I/F 115 controls the data communication between the control device 100 and the printer device 300.

The HDD 160 is a large-capacity storage medium for storing image data and programs. The present exemplary embodiment is described taking the HDD 160 as an example of the storage medium. Alternatively, a Blu-ray (registered trademark) Disc, a flash memory, or a digital versatile disc (DVD) may be used so long as it is possible to read from and write to the storage medium.

A timer 119 has a clock function and is used by the CPU 111 to measure time.

A system bus 117 is a bus that connects these units and is used to transfer data.

The reader device 200 includes a document conveyance unit (document feeder (DF) or automatic document feeder (ADF)) 250, which conveys a document, and a scanner controller 210, which optically reads an image of a document and converts the read image into image data as an electric signal.

The document conveyance unit 250 includes a document sensor 202, which detects the presence or absence of a document placed on the document conveyance unit 250.

The scanner controller 210 includes an opening and closing sensor 201, which detects that a document cover (pressure plate) included in the reader device 200 has been opened and closed.

The printer device 300 includes a sheet feeding unit 320, which includes sheet feeding cassettes and a manual-bypass tray for storing print sheets, a printer controller 310, which controls the printing of an image, and a sheet discharge unit 330, which performs a sorting process or a stapling process on sheets on which images have been printed.

The image forming apparatus 400 executes a plurality of types of jobs using these components.

For example, the image forming apparatus 400 executes a copy job for reading an image of a document using the reader device 200, generating image data representing the read image of the document, and printing an image on a sheet based on the image data using the printer device 300.

Further, the image forming apparatus 400 executes a scan transmission job for reading an image of a document using the reader device 200, and transmitting image data representing the read image of the document to the host computer 610 via the NIC 120.

Further, the image forming apparatus 400 executes a print job for analyzing print data received from the host computer 610 via the NIC 120, generating image data, and printing an image on a sheet based on the generated image data.

Further, the image forming apparatus 400 executes a scan storage job for reading an image of a document using the reader device 200, and saving image data representing the read image of the document in the HDD 160. Further, the image forming apparatus 400 executes a box print job for printing an image on a sheet based on image data stored in the HDD 160 by the scan storage job.

Further, the image forming apparatus 400 executes a facsimile transmission job for reading an image of a document using the reader device 200, converting image data representing the read image of the document into code data, and transmitting the converted code data to an external facsimile apparatus via the telephone circuit.

Further, the image forming apparatus 400 executes a facsimile print job for receiving code data from an external facsimile apparatus via the telephone circuit, converting the received code data into image data, and printing an image on a sheet based on the converted image data.

An exemplary embodiment has been described where the image forming apparatus 400 executes a plurality of types of jobs. This exemplary embodiment is not limiting. Alternatively, the image forming apparatus 400 may be able to execute at least one of the plurality of types of jobs.

Next, the power state of the image forming apparatus 400 is described.

The power source device 10 includes an alternating current/direct current (AC/DC) converter 13, which converts alternating current supplied from the AC power source 11 into direct current, and switch units 14 to 17. A switch 12 is used to turn on or off the image forming apparatus 400. To turn on the image forming apparatus 400, the user turns on the switch 12. To turn off the image forming apparatus 400, the user turns off the switch 12.

When the switch 12 is off, the supply of power from the AC power source 11 to the AC/DC converter 13 is cut off. When, on the other hand, the switch 12 is on, power is supplied from the AC power source 11 to the AC/DC converter 13, and the AC/DC converter 13 converts alternating current into direct current.

A power source control unit 122 turns on the switch units 14 to 17, thereby supplying power from the AC/DC converter 13 of the power source device 10 to the control device 100, the reader device 200, the printer device 300, and the image processing unit 35. On the other hand, the power source control unit 122 turns off the switch units 14 to 17, thereby cutting off power from the AC/DC converter 13 of the power source device 10 to the control device 100, the reader device 200, the printer device 300, and the image processing unit 35.

If the switch unit 14 has been turned on, the power source device 10 supplies power to the control device 100. If the switch unit 15 has been turned on, the power source device 10 supplies power to the printer device 300. If the switch unit 16 has been turned on, the power source device 10 supplies power to the reader device 200. If the switch unit 17 has been turned on, the power source device 10 supplies power to the image processing unit 35.

The power state of the image forming apparatus 400 changes depending on whether the power source control unit 122 turns on or off the switch units 14 to 17. A standby mode (normal mode) is a mode where all of the switch units 14 to 17 are turned on, and power is supplied to all of the control device 100, the reader device 200, the printer device 300, and the image processing unit 35, thereby executing the plurality of types of jobs described above. On the other hand, a sleep mode is a mode where all of the switch units 14 to 17 are turned off to make the power consumption of the image forming apparatus 400 smaller than in the standby mode.

Specifically, all of the switch units 14 to 17 are set to off so that the image forming apparatus 400 transitions to the sleep mode. This can reduce the power consumption of the image forming apparatus 400.

While the image forming apparatus 400 is in the sleep mode, the power source control unit 122 supplies and cuts off power according to an instruction from the CPU 111. While, on the other hand, power to the control device 100 is cut off, the power source control unit 122 receives an interrupt signal from another unit. If an interrupt signal is received, the power source control unit 122 starts the control device 100.

Examples of another unit include the opening and closing sensor 201, the document sensor 202, the NIC 120, the operation unit 150, and the modem 121. Even if the image forming apparatus 400 has transitioned to the sleep mode, the power source device 10 always supplies power to these units. The power source device 10 always supplies power also to the timer 119. The timer 119, however, does not transmit an interrupt signal and therefore is not described here.

If each of the units including the opening and closing sensor 201, the document sensor 202, the NIC 120, the operation unit 150, and the modem 121 has detected a return trigger for returning from the sleep mode, the unit transmits an interrupt signal to the power source control unit 122.

For example, if the opening and closing sensor 201 has detected the operation of opening and closing of the document cover, the opening and closing sensor 201 transmits an interrupt signal to the power source control unit 122. Further, if the document sensor 202 has detected that a document has been placed on the document conveyance unit 250, the document sensor 202 transmits an interrupt signal to the power source control unit 122. Further, if the NIC 120 has received a print job from the external host computer 610, the NIC 120 transmits an interrupt signal to the power source control unit 122. If an operation has been received from the user through the operation unit 150, the operation unit 150 transmits an interrupt signal to the power source control unit 122. Further, if a facsimile print job has been received from an external facsimile apparatus via the modem 121, the modem 121 transmits an interrupt signal to the power source control unit 122.

In the present exemplary embodiment, to reduce cost, the number of input pins for signal lines to the power control unit 122 is reduced, and these interrupt signals are input to the power control unit 122 by taking the logical sum of the interrupt signals. Thus, the power source control unit 122 cannot determine whether an interrupt signal has been transmitted from the opening and closing sensor 201 or the document sensor 202.

If an interrupt signal is received, the power source control unit 122 switches on the switch units 14 to and returns the image forming apparatus 400 from the sleep mode to the standby mode. Then, the power source control unit 122 transmits information indicating the reception of an interrupt signal and a signal indicating the transmission source of the interrupt signal to the CPU 111. Since the interrupt signals from the document sensor 202 and the opening and closing sensor 201 are transmitted to the power source control unit 122 by taking the logical sum of the interrupt signals, the transmission sources of these interrupt signals are not distinguished, and the CPU 111 is notified that the reader device 200 is the transmission source.

In the present exemplary embodiment, an example has been described where, if the CPU 111 has received an interrupt signal from any of the NIC 120, the modem 121, the operation unit 150, the opening and closing sensor 201, and the document sensor 202, the CPU 111 turns on all of the switch units 14 to 17. The present exemplary embodiment, however, is not limited to this. Alternatively, the transmission source of the interrupt signal may be determined, and power may be supplied only to the devices that are expected to be used, according to the determined transmission source.

For example, if the power source control unit 122 has received an interrupt signal from the opening and closing sensor 201 or the document sensor 202, the power source control unit 122 may start the main control unit 100 and then notify the CPU 111 of information indicating that the power source control unit 122 has received an interrupt signal from the opening and closing sensor 201 or the document sensor 202.

Based on the information, the CPU 111 may presume that the reader device 200 is to be used. Then, the CPU 111 may turn on only the switch units 16 and 17 with the switch unit 15 remaining turned off, thereby starting the reader device 200 and the image processing unit 35 without starting the printer device 300.

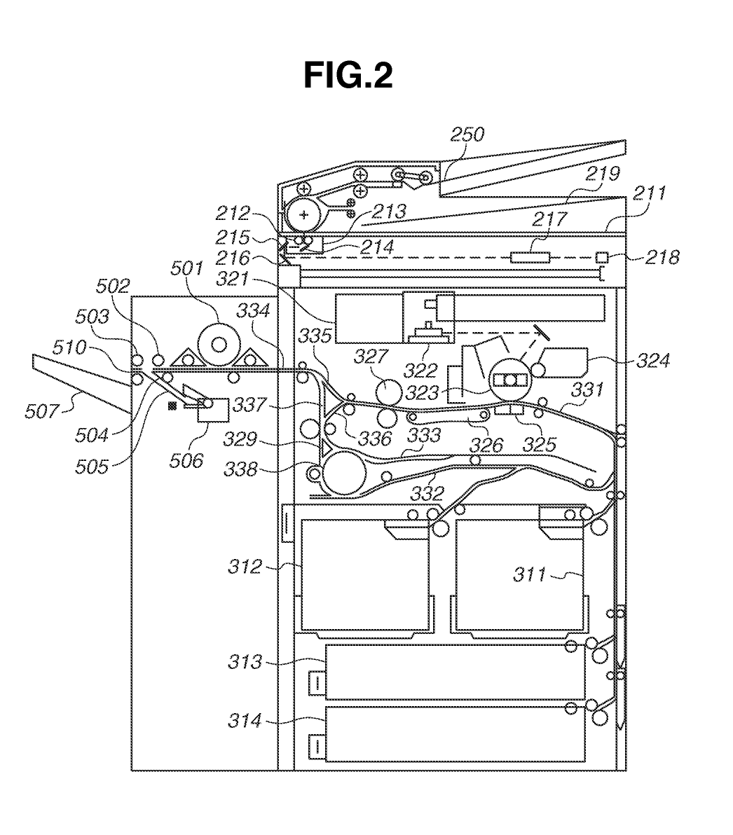

Next, with reference to a cross-sectional view illustrated in FIG. 2, the configuration of the image forming apparatus 400 is described. FIG. 2 is a cross-sectional view of the reader device 200 and the printer unit 300 of the image forming apparatus 400. First, the reader device 200 is described.

In the reader device 200, the document conveyance unit (DF) 250 feeds documents placed on an automatic document conveyance unit, one by one from the top and conveys the document onto a platen glass 211.

If the document has been conveyed onto the platen glass 211, the scanner controller 210 lights up a light-emitting diode (LED) 212 to perform exposure scanning on the document. At this time, the reflected light from the document is guided to a charge-coupled device (CCD) image sensor (hereinafter referred to as a “CCD”) 218 by mirrors 214, 215, and 216 and a lens 217. Then, the reflected light is read by the CCD 218. The CCD 218 generates image data based on the reflected light it reads and transfers the generated image data to the control device 100. The read document is discharged to a document discharge tray 219. Although a description has been given taking a CCD as an example, this description is not limiting. Alternatively, a contact image sensor (CIS) may be used. If a CIS is used, the mirrors 214 to 216 and the lens 217 are not necessary.

Next, the printer device 300 is described.

In the printer device 300, a laser driver 321 drives a laser-emitting unit 322. The laser driver 321 causes the laser-emitting unit 322 to emit laser light according to image data output from the control device 100. A photosensitive drum 323 is irradiated with the laser light, thereby forming a latent image according to the laser light on the photosensitive drum 323. A developing device 324 applies a developer to the portion of the latent image on the photosensitive drum 323. Although a description has been given of exposure performed with laser light, exposure may also be performed with an LED array sensor.

The printer device 300 includes sheet feeding cassettes 311, 312, 313, and 314 as the sheet feeding unit 320. The user replenishes print sheets by pulling out a sheet feeding cassette, refilling the pulled out sheet feeding cassette with print sheets, and closing the sheet feeding cassette.

The printer device 300 feeds a sheet from one of the sheet feeding cassettes 311, 312, 313, and 314 and conveys the fed sheet to a transfer unit 325 through a conveying path 331. The transfer unit 325 transfers the developer applied to the photosensitive drum 323 onto the sheet.

The sheet onto which the developer has been transferred is conveyed to a fixing unit 327 by a conveying belt 326, and the developer is fixed to the sheet by the heat and the pressure of the fixing unit 327. Then, the sheet having passed through the fixing unit 327 travels along conveying paths 335 and 334 and is discharged to the outside of the printer device 300. When the sheet is discharged to the outside of the printer device 300 with the printed side reversed, the sheet is conveyed to a conveying path 338 through a conveying path 336 and then conveyed in the opposite direction. Then, the sheet is discharged to the outside of the printer device 300 through a conveying path 337 and the conveying path 334.

Further, if two-sided printing is to be performed, the sheet passes through the fixing unit 327 and then is guided to a conveying path 333 through the conveying path 336 by a flapper 329. Then, the sheet is conveyed in the opposite direction and guided to the conveying path 338 and a re-feeding conveying path 332 by the flapper 329. The sheet guided to the re-feeding conveying path 332 passes through the conveying path 331 at the timing described above and is fed to the transfer unit 325. The sheet discharged from the conveying path 334 is conveyed to a sheet discharge unit 330, regardless of whether one-sided or two-sided printing. The sheet conveyed to the sheet discharge unit 330 is sent to a buffer unit 501. The buffer unit 501 buffers the conveyed sheet by winding the sheet around a buffer roller as needed. For example, if it takes time to perform the stapling process downstream of the buffer unit 501, the buffer unit 501 stores the sheet by winding the sheet around the buffer roller. This enables stapling of sheets by preventing the collision of the sheets while maintaining a constant speed in conveying each sheet from the main body of the printer device 300.

Then, the sheet is discharged to a sheet discharge tray 507 through a conveying path 510 by an upstream discharge roller pair 502 and a downstream discharge roller pair 503.

Further, if stapling is to be performed, immediately after the rear edge of the sheet conveyed by the upstream discharge roller pair 502 has passed through the upstream discharge roller pair 502, the sheet is pulled back by a knurled belt 504 and discharged to a stack tray 505. Then, after a predetermined number of sheets have been stacked, the sheets are subjected to the stapling process by a stapling unit 506 and then discharged to the discharge tray 507 by the downstream discharge roller pair 503. Further, if shift sorting is performed, sheets stacked in the stack tray 505 are shifted to left and right and discharged to the discharge tray 507, thereby clarifying the boundaries between bundles of the sheets.

In the present exemplary embodiment, an example has been described where the image forming apparatus 400 performs printing using an electrophotographic method. Alternatively, in another exemplary embodiment, printing is performed using an inkjet method for discharging inks. In yet another exemplary embodiment, an apparatus need not include the printer device 300 but include only the components other than the printer device 300.

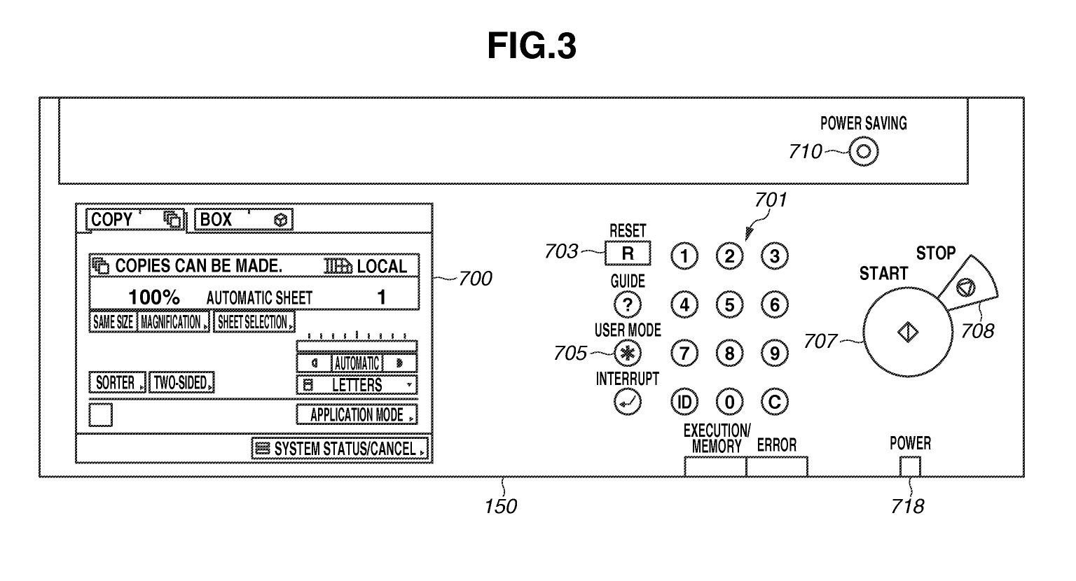

Next, with reference to FIG. 3, the configuration of the operation unit 150 is described.

As illustrated in FIG. 3, the operation unit 150 includes a touch panel unit 700 and a group of hardware keys.

The touch panel unit 700 includes a liquid crystal display (display unit) to which a touch panel sheet is attached. The touch panel unit 700 displays an operation screen and receives an operation from the user through the touch panel sheet. Further, the touch panel unit 700 is used to display the state of the image forming apparatus 400 and preview an image.

A numeric keypad 701 is used to input numeric values from 0 to 9 and used to input the number of copies for a copy job and the destination of a facsimile transmission job. A reset key 703 is a key for resetting the set number of copies and the other settings of a job.

A user mode key 705 is a key for making advanced settings for the operation of the image forming apparatus 400.

A start key 707 is a key for receiving an instruction to start reading a copy job or scan transmission. A stop key 708 is a key for cancelling a job in execution.

A power saving key 710 is a switch for switching the power state of the image forming apparatus 400. If the power saving key 710 has been pressed when the image forming apparatus 400 is in the standby mode, the image forming apparatus 400 transitions to the sleep mode. If, on the other hand, the power saving key 710 has been pressed when the image forming apparatus 400 is in the sleep mode, the image forming apparatus 400 transitions to the standby mode.

A power LED 718 lights up when the image forming apparatus 400 is in the standby mode. The power LED 718 goes out when the image forming apparatus 400 is in the sleep mode.

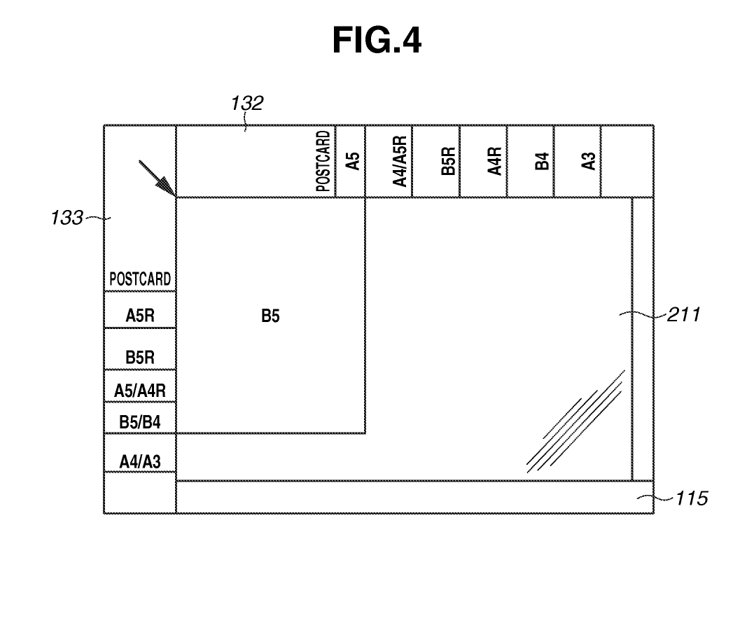

FIG. 4 is a diagram illustrating a document placed on the platen glass 211 of the reader device 200.

To the left of and above the platen glass 211 in FIG. 4, a main scanning direction size indicator plate 133 and a sub-scanning direction size indicator plate 132 are provided. The user places a document on a document platen using the main scanning direction size indicator plate 133 and the sub-scanning direction size indicator plate 132 as guides. In the example of FIG. 4, a B5-size document is placed.

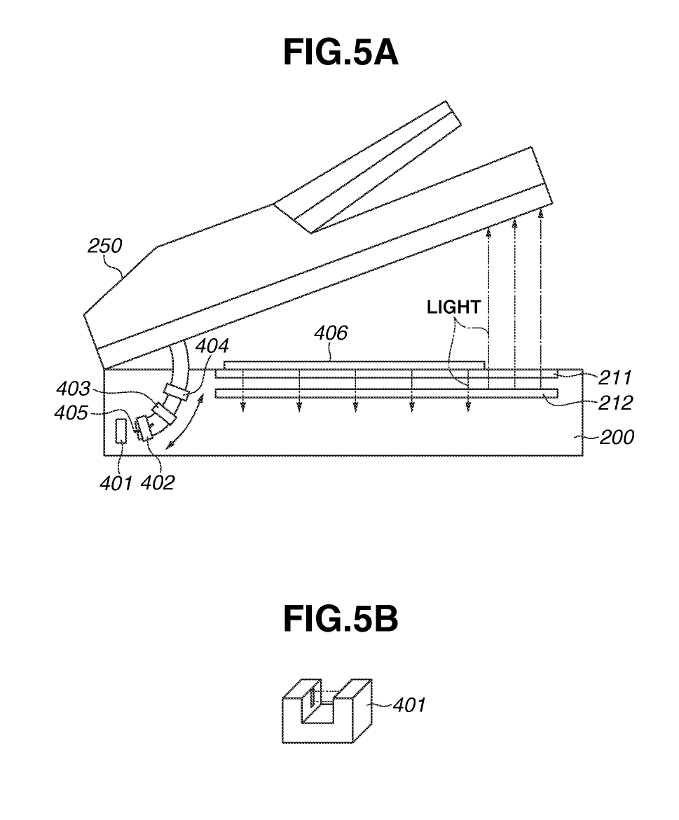

FIG. 5A is a diagram illustrating the process of detecting the size of a document placed on the document platen.

Based on an instruction from the scanner controller 210, the LED 212 emits light. In the area where a document 406 is present, the document 406 reflects the light, whereas the area where the document 406 is not present, the document 406 does not reflect the light emitted from the LED 212. The light reflected from the document 406 is guided to the CCD 218 by the mirrors 214, 215, and 216 and the lens 217. The CCD 218 converts the read light into a signal and transmits the signal to the scanner controller 210. The scanner controller 210 transfers the received signal to the CPU 111, and the CPU 111 determines based on the signal the area where the document 406 is present, thereby detecting the size of the document 406.

If the user has opened the document cover to set a document on the platen glass 211, opening and closing detection sensors 401, 402, 403, and 404 attached to a suitable plate detect the operation of opening and closing of the document cover and the opening and closing angle of the document cover. The opening and closing detection sensors 401, 402, 403, and 404 correspond to the opening and closing detection sensor 201 in FIG. 1.

FIG. 5B is a perspective view of the external appearance of a photointerrupter (the four opening and closing detection sensors 401, 402, 403, and 404). The four opening and closing detection sensors 401, 402, 403, and 404 have similar structures. The photointerrupter included in each opening and closing detection sensor is known and outputs different signals depending on whether or not a fin 405 is located in a space in the photointerrupter.

If the document cover is in a closed state, the opening and closing detection sensor 401 detects that the light radiated inside the photointerrupter and received inside the photointerrupter is blocked by the fin 405. If the user attempts to push up the document cover in this state, the fin 405 located in the opening and closing detection sensor 401 comes off, and the opening and closing detection sensor 401 detects the coming off of the fin 405. The detected signal is transmitted as an interrupt signal to the CPU 111. Based on the interrupt signal, the CPU 111 detects that the document cover has been opened. Further, if power is being supplied to the scanner controller 210 at this time, the detected signal is transmitted also to the scanner controller 210. The scanner controller 210 transmits the transmitted signal to the CPU 111. The CPU 111 determines the opening and closing angle of the document cover based on this signal.

Further, the opening and closing detection sensor 402 is disposed to detect that the document cover has opened 30°. The opening and closing detection sensor 403 is disposed to detect that the document cover has opened 45°. The opening and closing detection sensor 404 is disposed to detect that the document cover has opened 70°.

To detect the size of the document placed on the platen glass 211, the CPU 111 uses the LED 212 to irradiate the document with light when the opening and closing detection sensor 402 has detected the fin 405, that is, when the opening and closing detection sensor 402 has detected that the document cover has opened 30°. Then, the CPU 111 uses the CCD 218 to read the reflected light from the document and determines the size of the document based on the area where the reflected light has been obtained. As described above, the size of the document placed on the document platen is detected when the opening angle of the document cover is small. The reason why the size of the document is not detected when the opening angle of the document cover is great is to irradiate the document with light in the state where outside light enters with difficulty, and then perform a reading process for reading the reflected light from the document, thereby accurately determining the size of the document.

The image forming apparatus 400 as described above transitions to the above sleep mode, thereby enabling the reduction in the power consumption of the image forming apparatus 400. Then, it takes several seconds for the image forming apparatus 400 to detect a return trigger for returning from the sleep mode, turn on the switch units 14 to 17, and transition to the standby mode, where the image forming apparatus 400 can execute a job. It takes 5 seconds for the image forming apparatus 400 according to the present exemplary embodiment to perform these processes.

Further, the reader device 200 cannot detect the size of the document with the document cover closed. The reason for this is that a reference plate of the document cover for holding down the document is formed of a white member so that the portion other than the document is not colored, and therefore, if the document cover is closed, it is difficult to distinguish the boundary between the document and the reference plate. That is, the reader device 200 reads the size of the document under a situation in which the reflected light returns from the document, while no reflected light returns from where the document is not present or a small amount of reflected light returns from some part, in the course of closing the document cover.

Thus, if the document cover is closed before the transition of the image forming apparatus 400 from the sleep mode to the standby mode is completed, the scanner controller 210 cannot irradiate the document with light using the LED 212 and read the reflected light from the document as described above. Consequently, the image forming apparatus 400 cannot detect the size of the document.

Accordingly, after the operation of opening and closing of the document cover has been performed and the transition from the sleep mode to the standby mode has been completed, if the size of the document cannot be determined even though the document cover is closed, the image forming apparatus 400 according to the present exemplary embodiment prompts the user to open and close the document cover. This enables the image forming apparatus 400 to determine the size of the document even if the user does not manually input the size of the document by operating the operation unit 150.

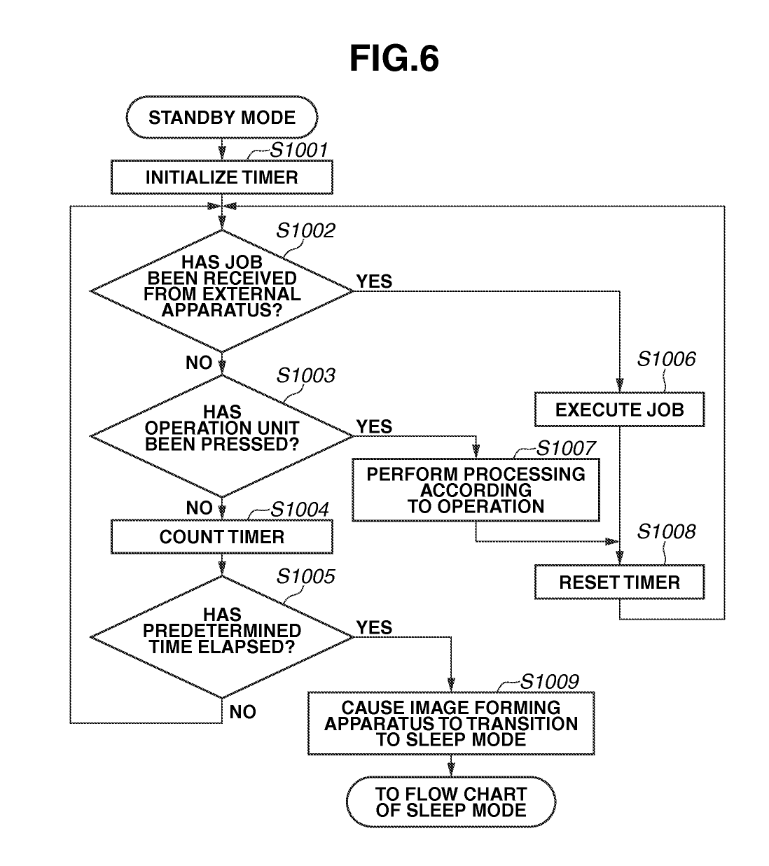

FIG. 6 is a flow chart illustrating the processing performed in the state where the image forming apparatus 400 is in the standby mode. The processing in FIG. 6 is achieved by the CPU 111 reading a program stored in the ROM 113 into the RAM 112 and executing the program.

In step S1001, the CPU 111 stores in the RAM 112 a variable that saves the value of a timer and initializes the variable to 0. After that, with reference to the timer 119, the CPU 111 counts up the value of the timer in the RAM 112.

In step S1002, the CPU 111 determines whether or not a job has been received from an external apparatus. For example, if a print job has been received from the host computer 610, or if a facsimile print job has been received from an external facsimile apparatus via the modem 121 (Yes in step S1002), the processing proceeds from step S1002 to step S1006. In step S1006, the CPU 111 executes the received job, and the processing proceeds to step S1008. The term “job” refers to either a print job or a facsimile print job described above. In step S1008, the CPU 111 resets (initializes) the value of the timer in the RAM 112 to 0.

If, on the other hand, a job has not been received from an external apparatus (No in step S1002), the processing proceeds from step S1002 to step S1003.

In step S1003, the CPU 111 determines whether or not any one of the keys of the operation unit 150 has been pressed. If any one of the keys of the operation unit 150 has been pressed (Yes in step S1003), the processing proceeds to step S1007. In step S1007, the CPU 111 performs processing according to the pressed key. Examples of the processing according to the pressed key include an input of a numeric value through the numeric keypad 701 and an instruction to execute a job through the start key 707. In step S1008, the CPU 111 resets (initializes) the value of the timer to 0.

If, on the other hand, none of the keys of the operation unit 150 has been pressed (No in step S1003), the processing proceeds to step S1004. In step S1004, the CPU 111 counts up the value of the timer, and the processing proceeds to step S1005.

In step S1005, the CPU 111 determines whether or not the counted value of the timer has reached a predetermined value. That is, it is determined whether or not a predetermined time has elapsed in the state where no job has been received from outside and no operation has been performed on the operation unit 150. If the CPU 111 has determined that the value of the timer has not reached the predetermined value (No in step S1005), the processing returns to step S1002. If, on the other hand, the CPU 111 has determined that the value of the timer has reached the predetermined value (Yes in step S1005), the processing proceeds to step S1009.

In step S1009, to reduce the power consumption of the image forming apparatus 400, the CPU 111 causes the image forming apparatus 400 to transition to the sleep mode. Specifically, the CPU 111 turns off the switch units 14 to 17 illustrated in FIG. 1 to cut off the supply of power to the reader device 200, the printer device 300, the control device 100, and the image processing unit 35.

As described above, the image forming apparatus 400 transitions to a power saving state.

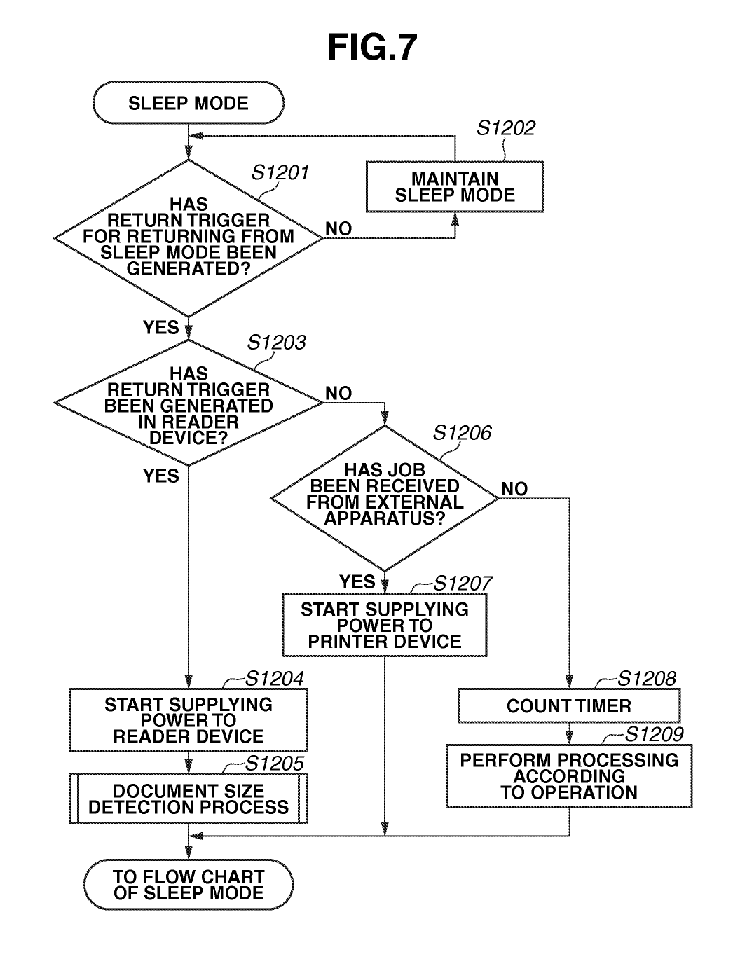

Next, with reference to a flow chart illustrated in FIG. 7, a description is given of control in which, after the image forming apparatus 400 has transitioned to the sleep mode, if a return trigger has been generated, the supply of power from the power source device 10 to the devices is started. In the present exemplary embodiment, an example is described where according to the type of the return trigger, power is supplied to the devices that are likely to be used after the return, and power is not supplied to the other devices. The processing in FIG. 7 is achieved under the control of the power source control unit 122 and by the CPU 111 reading a program stored in the ROM 113 into the RAM 112 and executing the program.

In step S1201, the CPU 111 determines whether or not a return trigger for returning from the sleep mode has been generated, based on whether or not an interrupt signal has been received from the power source control unit 122. As described above, examples of the return trigger for returning from the sleep mode include the reception of a print job from outside (for example, a print job or a facsimile print job), the pressing of any one of the keys of the operation unit 150, and the opening and closing of the document cover of the reader device 200. Further, not only if a print job has been received from the outside, but also if an instruction to execute a scan transmission job or a scan storage job has been received from the outside, the CPU 111 may determine, based on an interrupt signal from the power source control unit 122, that a return trigger for returning from the sleep mode has been generated. In step S1201, if the CPU 111 has determined that a return trigger for returning from the sleep mode has not been generated (No in step S1201), the processing proceeds to step S1202. In step S1202, the CPU 111 maintains the sleep mode.

If the CPU 111 has determined that a return trigger for returning from the sleep mode has been generated (Yes in step S1201), the processing proceeds to step S1203. In step S1203, the CPU 111 receives a signal indicating the transmission source of the interrupt signal from the power source control unit 122, thereby determining whether or not the return trigger has been generated in the reader device 200. If the CPU 111 has determined that the return trigger has been generated in the reader device 200 (Yes in step S1203), the processing proceeds to step S1204. If the CPU 111 has determined that the return trigger has not been generated in the reader device 200 (No in step S1203), the processing proceeds to step S1206. In step S1204, the CPU 111 turns on the switch unit 16 to start supplying power to the reader device 200.

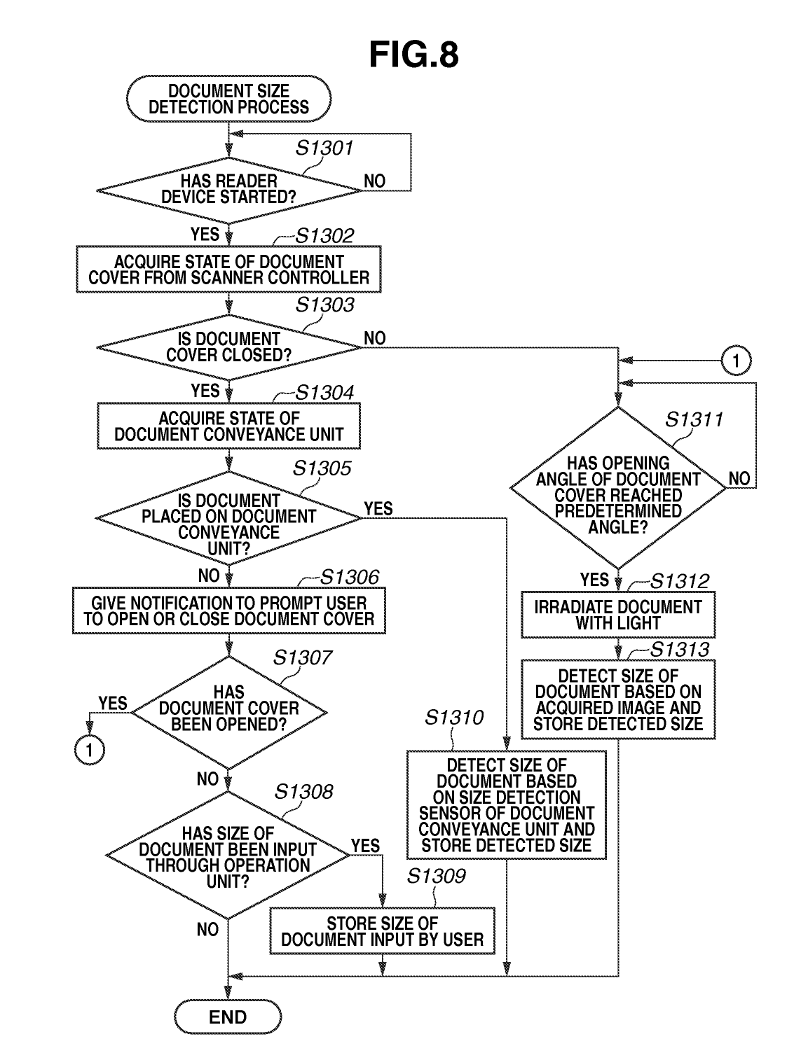

Then, in step S1205, the CPU 111 performs a document size detection process. The details of the document size detection process will be described later with reference to FIG. 8.

If, on the other hand, the processing has proceeded from step S1203 to step S1206, the CPU 111 determines whether or not a job has been received from an external apparatus. If the CPU 111 has determined that a job has been received from an external apparatus (Yes in step S1206), the processing proceeds to step S1207. If the CPU 111 has determined that a job has not been received (No in step S1206), the processing proceeds to step S1208. The processing proceeds from step S1206 to step S1208 if any one of the keys of the operation unit 150 has been pressed.

In step S1207, to perform the printing of the job received from the external apparatus, the CPU 111 turns on the switch unit 15 to start supplying power to the printer device 300.

If the processing has proceeded from step S1206 to step S1208, a copy job using both the reader device 200 and the printer device 300 is likely to be executed. Thus, the CPU 111 turns on the switch unit 16 to start supplying power to the reader device 200. Then, in step S1209, the CPU 111 turns on the switch unit 15 to start supplying power to the printer device 300.

Then, the CPU 111 ends the processing.

As described above, even in the sleep mode, the image forming apparatus 400 can return from the sleep mode to the standby mode if the document cover has been opened and closed, or if a document has been set, or if a job has been received from an external apparatus, or if any one of the keys of the operation unit 150 has been pressed. Further, according to the return trigger, power is supplied to the devices that are likely to be used in the processing after the return, and power is not supplied to the other devices. This can reduce the power consumption as compared to the case where power is supplied to all of the devices.

Next, with reference to a flow chart in FIG. 8, the details of the document size detection process performed in step S1205 in FIG. 7 are described. The processing in FIG. 8 is achieved by the CPU 111 reading a program stored in the ROM 113 into the RAM 112 and executing the program.

In step S1301, the CPU 111 determines whether or not the reader device 200 has started. In the present exemplary embodiment, it takes 5 seconds to start the reader device 200. The time it takes to start the reader device 200 is not limited to 5 seconds, but may be another period of time. The process of step S1301 is repeated until the reader device 200 starts. Then, if the CPU 111 has determined that the reader device 200 has started (Yes in step S1301), the processing proceeds to step S1302.

In step S1302, the CPU 111 acquires the state of the document cover from the scanner controller 210 of the reader device 200 having started.

In step S1303, the CPU 111 determines, based on a signal from the opening and closing sensor 401, whether or not the document cover is closed. If a signal from the opening and closing sensor 401 has been received, the CPU 111 determines that the document cover is closed. If a signal from the opening and closing sensor 401 has not been received, the CPU 111 determines that the document cover is not closed. If the CPU 111 has determined that the document cover is closed (Yes in step S1303), the processing proceeds to step S1304. If the CPU 111 has determined that the document cover is not closed (No in step S1303), the processing proceeds to step S1311. For example, if it has taken 5 seconds or more for the user to set a document since the document cover has been opened, the start of the reader device 200 is completed while the document cover is opened. In this case, the CPU 111 determines in step S1303 that the document cover is not closed. In such a case, when the document cover is closed, the reader device 200 irradiates the document with light at the time when the opening angle of the document cover has reached a predetermined angle (30° in the present exemplary embodiment), thereby detecting the size of the document. Specifically, in step S1311, the CPU 111 determines, based on the reception of a signal from the opening and closing sensor 402, that the opening angle of the document cover has reached 30°. The process of step S1311 is repeated until the opening angle of the document cover reaches the predetermined angle. If the CPU 111 has determined that the opening angle of the document cover has reached the predetermined angle (Yes in step S1311), the processing proceeds from step S1311 to step S1312. In step S1312, the CPU 111 instructs the reader device 200 to irradiate the document with light. After the reader device 200 has irradiated the document with light, the CCD 218 reads the reflected light from the document. The CPU 111 detects the edges of the document from the read image, thereby detecting the size of the document. The CPU 111 stores the detected size of the document in the RAM 112.

If, on the other hand, the processing proceeds from step S1303 to step S1304, then in step S1304, the CPU 111 determines, based on a signal from the document sensor 202, whether a document is placed on the document conveyance unit 250. The CPU 111 makes this determination not based on an interrupt signal but on a signal received from the document sensor 202 via the scanner controller 210. If the CPU 111 has determined that a document is placed on the document conveyance unit 250 (Yes in step S1305), the processing proceeds to step S1310. In step S1310, the CPU 111 detects the size of the document with a size detection sensor included in the document conveyance unit 250 and stores the detected size of the document in the RAM 112. The size of the document is thus confirmed.

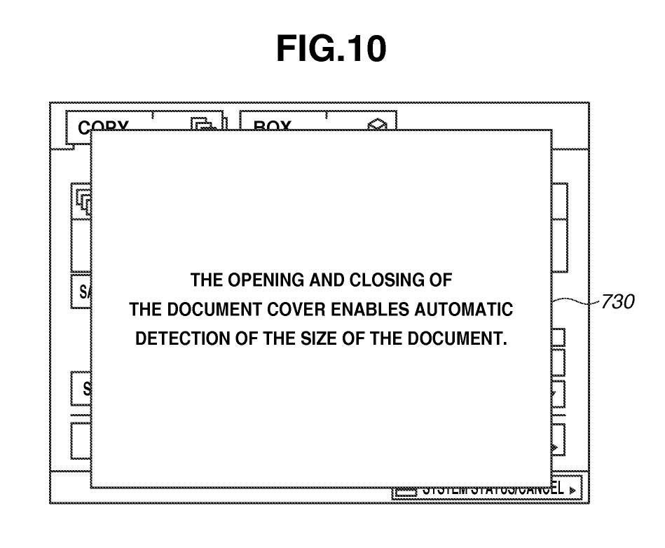

If the CPU 111 has determined that a document is not placed on the document conveyance unit 250 (No in step S1305), the processing proceeds to step S1306. In this case, although the return trigger has been generated in the reader device 200, a document is not placed on the document conveyance unit 250. Thus, it is likely that a document is placed on the document platen. It is, however, not possible to detect the size of the document with the document cover closed. This is because a reference plate of the document cover for holding down the document is formed of a white member so that the portion other than the document is not colored, and therefore, if the document cover is closed, it is difficult to distinguish the boundary between the document and the reference plate. Accordingly, in step S1306, the CPU 111 gives notification to prompt the user to open and close the document cover. FIG. 10 is an example of a screen displayed on the operation unit 150 to prompt the user to open and close the document cover. A message 730 indicates that the opening and closing of the document cover enables automatic detection of the size of the document.

In step S1307, the CPU 111 determines, based on a signal from the opening and closing sensor 401, whether or not the document cover has been opened. The CPU 111 determines that the document cover has been opened when the reception of a signal from the opening and closing sensor 401 has stopped, or when a signal has been received from any one of the opening and closing sensors 402 to 404. If the CPU 111 has determined that the document cover has been opened (Yes in step S1307), the processing proceeds to step S1311. If, on the other hand, the CPU 111 has determined that the document cover has not been opened (No in step S1307), and the CPU 111 has determined in step S1308 that the size of the document has been input through the operation unit 150 (Yes in step S1308), the processing proceeds to step S1309. If, on the other hand, the CPU 111 has determined that the document cover has not been opened (No in step S1307), and the CPU 111 has determined that the size of the document has not been input through the operation unit 150 (No in step S1308), the CPU 111 does not store the size of the document in the RAM 112 and ends the processing illustrated in FIG. 8.

After the processing has proceeded from step S1307 to step S1311, then as described above, the CPU 111 performs the processes of steps S1311 to S1313, in which the CPU 111 detects the size of the document and stores the detected size of the document in the RAM 112. Specifically, in step S1311, the CPU 111 determines whether or not the opening angle of the document cover has reached the predetermined angle (30°). The process of step S1311 is repeated until the opening angle of the document cover reaches the predetermined angle. If the CPU 111 has determined that the opening angle of the document cover has reached the predetermined angle (Yes in step S1311), the processing proceeds from step S1311 to step S1312. In step S1312, the CPU 111 instructs the reader device 200 to irradiate the document with light. After the reader device 200 has irradiated the document with light, the CCD 218 reads the reflected light from the document. In step S1313, the CPU 111 detects from the read image the area where the document is present, thereby detecting the size of the document based on the detected area. The CPU 111 stores the detected size of the document in the RAM 112.

As described above, the document size detection process ends.

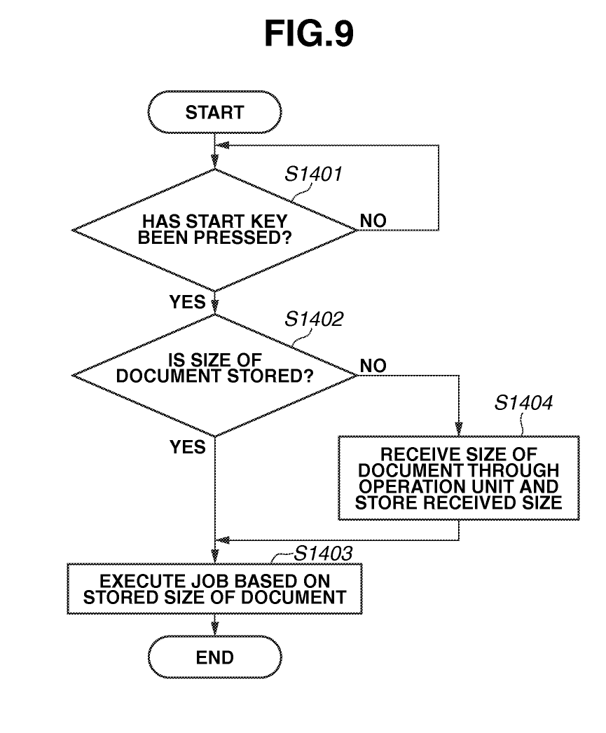

Next, with reference to a flow chart in FIG. 9, the process of executing a copy job according to the detected size of the document is described. The processing in FIG. 9 is one of the examples of the processing performed in step S1007 illustrated in FIG. 6. The processing in FIG. 9 is achieved by the CPU 111 reading a program stored in the ROM 113 into the RAM 112 and executing the program.

In step S1401, the CPU 111 determines whether or not the start key 707 has been pressed. The process of step S1401 is repeated until the start key 707 is pressed. Then, if the CPU 111 has determined that the start key 707 has been pressed (Yes in step S1401), the processing proceeds to step S1402.

In step S1402, the CPU 111 determines whether or not the size of the document is stored in the RAM 112. If the CPU 111 has determined that the size of the document is stored (Yes in step S1402), the processing proceeds to step S1403. If the CPU 111 has determined that the size of the document is not stored (No in step S1402), the processing proceeds to step S1404.

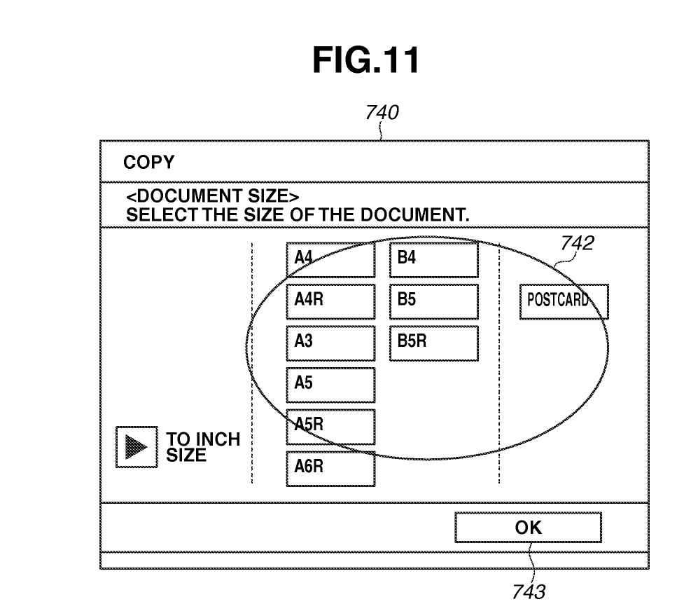

In step S1404, the CPU 111 displays on the operation unit 150 a screen for receiving the size of the document and receives the size of the document from the user. A screen illustrated in FIG. 11 is an example of display of the screen for receiving the size of the document. The user presses one of document size specifying buttons 742. If the user has pressed one of the document size specifying buttons 742, the pressed document size specifying button 742 enters a selected state. When the user has pressed an OK button 743 with the pressed document size specifying button 742 in the selected state, the CPU 111 stores in the RAM 112 the size of the document indicated by the selected document size specifying button 742, and the processing proceeds to step S1403.

In step S1403, the CPU 111 executes a copy job based on the size of the document stored in the RAM 112. Specifically, the CPU 111 sets an area read by the reader device 200 to be an area corresponding to the size of the document stored in the RAM 112. Alternatively, if the user has specified the size of a print sheet and instructed the CPU 111 to change the magnification according to the size of the print sheet, the CPU 111 determines the magnification of the image according to the size of the document and the size of the print sheet.

As described above, even if the size of the document placed on the document platen has not been detected after the start of the reader device 200, the user is notified that the opening and closing of the document cover enables automatic detection of the size of the document. Then, if the user opens and closes the document cover, the size of the document is automatically detected, thereby enabling the execution of the copy job according to the detected size of the document. Thus, the user can avoid the inconvenience of inputting the size of the document.

In the first exemplary embodiment, an example has been described where, after the document cover has been closed, the user is prompted to open and close the document cover to detect the size of the document.

In a second exemplary embodiment, a description is given of control processing in which, if the reader device 200 starts based on a return trigger from the reader device 200, notification is given to the operation unit 150 to warn the user not to close the document cover. This is the control for securing the time for completing the start of the reader device 200 before the document cover is closed. This is because the start of the reader device 200 is completed before the document cover is closed, thereby enabling the reader device 200 to automatically detect the size of the document when the document cover is closed.

The configuration of the image forming apparatus 400 is similar to that described in the first exemplary embodiment and therefore is not described in detail. Only the differences from the first exemplary embodiment are described here.

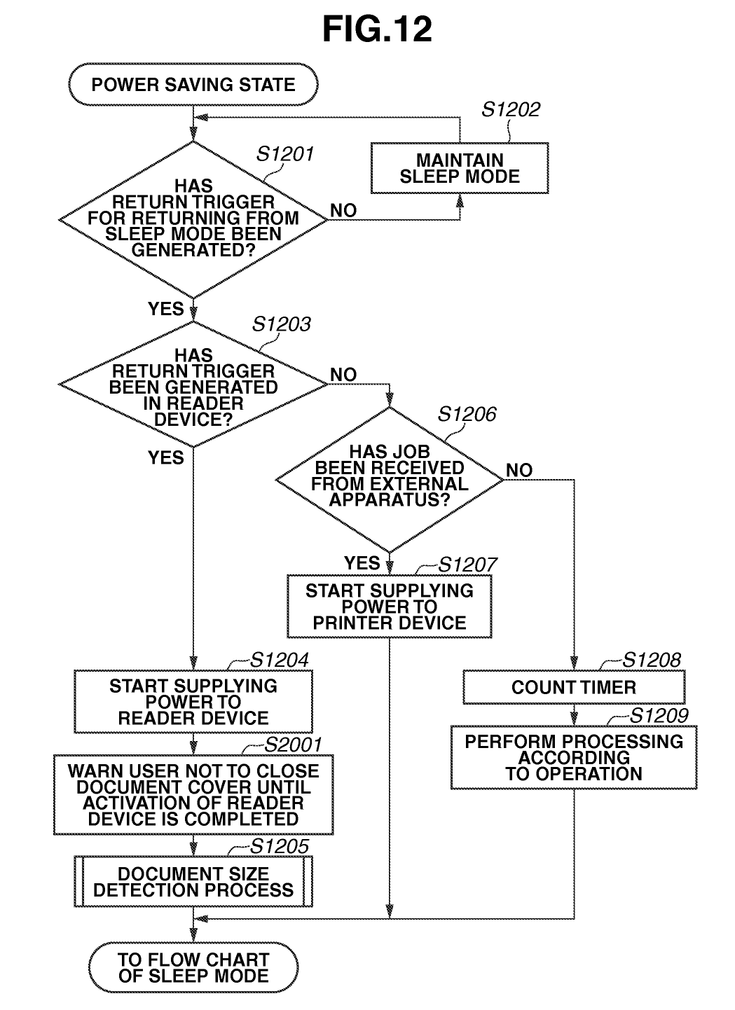

In the second exemplary embodiment, the processing of a flow chart illustrated in FIG. 12 is performed instead of the flow chart illustrated in FIG. 7 in the first exemplary embodiment. The processing in FIG. 12 is achieved under the control of the power source control unit 122 and by the CPU 111 reading a program stored in the ROM 113 into the RAM 112 and executing the program. Among the steps illustrated in FIG. 12, the steps similar to those illustrated in FIG. 7 are designated by the same numerals.

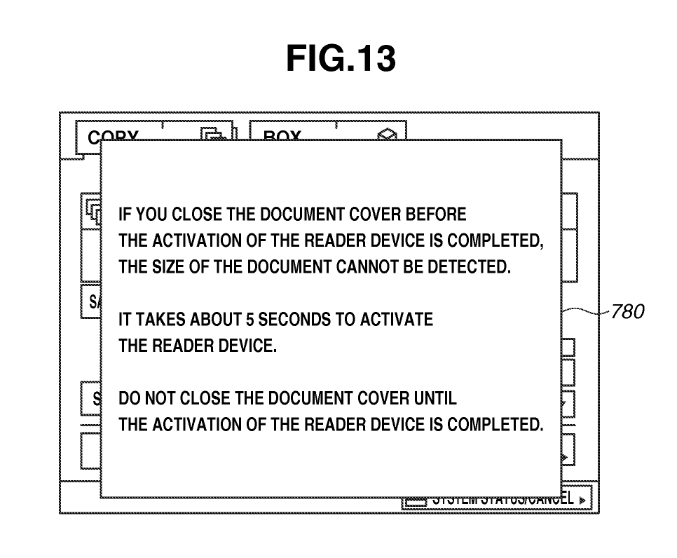

In the second exemplary embodiment, in step S1204, the CPU 111 starts supplying power to the reader device 200. Then, in step S2001, the CPU 111 warns the user not to close the document cover until the reader device 200 starts. Specifically, the CPU 111 displays on the operation unit 150 a screen illustrated in FIG. 13. On the screen illustrated in FIG. 13, the CPU 111 displays a message 780 informing the user that if the document cover is closed before the activation of the reader device 200 is completed, the size of the document cannot be detected. Further, the CPU 111 displays a message notifying the user that it takes 5 seconds until the reader device 200 is activated, and a message for warning the user not to close the document cover until the activation of the reader device 200 is completed. In the present exemplary embodiment, the time of 5 seconds is a fixed value. Alternatively, in another exemplary embodiment, if the time to complete the activation of the reader device 200 dynamically changes depending on the state of the image forming apparatus 400, the CPU 111 may predict and display the time till completion of the activation of the reader device 200.

Then, the processing proceeds to step S1205.

Thus, the control is performed, whereby, if the reader device 200 is activated based on a return trigger from the reader device 200, notification can be given in the operation unit 150 to warn the user not to close the document cover.

In the first exemplary embodiment, an example has been described where, after the document cover has been closed, the user is prompted to open and close the document cover to detect the size of the document, even if the user does not press the start key 707.

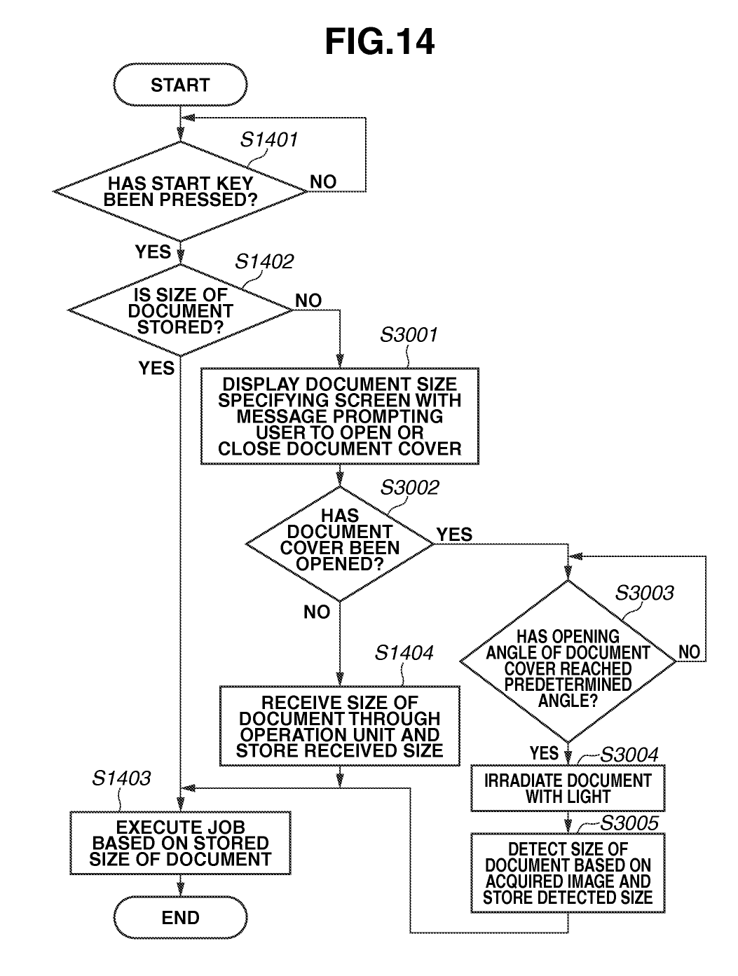

In a third exemplary embodiment, the processing of a flow chart illustrated in FIG. 14 is performed instead of the flow chart illustrated in FIG. 9 in the first exemplary embodiment. In the third exemplary embodiment, an example is described where, if the user has after that pressed the start key 707 without opening and closing of the document cover, a document size specifying screen including a message prompting the user to open and close the document cover to detect the size of the document, or a message prompting the user to input the size of the document is displayed.

The configuration of the image forming apparatus 400 is similar to that described in the first exemplary embodiment and therefore is not described in detail. Only the differences from the first exemplary embodiment are described here.

In the third exemplary embodiment, the processing of the flow chart illustrated in FIG. 14 is performed instead of the flow chart illustrated in FIG. 9 in the first exemplary embodiment.

The processing in FIG. 14 is one of the examples of the processing performed in step S1007 illustrated in FIG. 6.

The processing is effective particularly if, after the completion of the activation of the reader device 200, the start key 707 has been pressed without the opening and closing of the document cover and an input of the size of the document through the operation unit 150.

The processing in FIG. 14 is realized by the CPU 111 reading a program stored in the ROM 113 into the RAM 112 and executing the program. Among the steps illustrated in FIG. 14, the steps similar to those illustrated in FIG. 9 are designated by the same numerals.

In step S1402, if the size of the document is not stored in the RAM 112 (No in step S1402), the processing proceeds to step S3001.

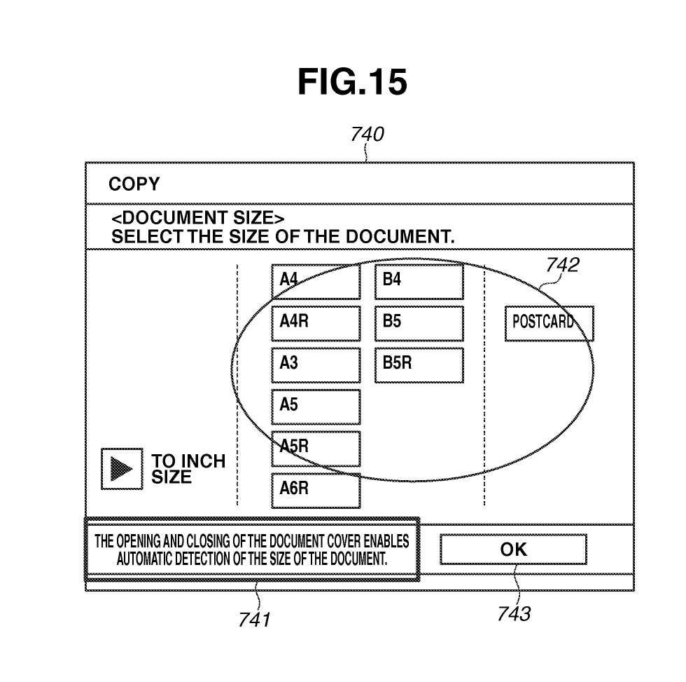

In step S3001, the CPU 111 displays on the operation unit 150 a screen for receiving the size of the document. A screen illustrated in FIG. 15 is an example of the display of the screen for receiving the size of the document. On this screen, a message 741 is also displayed, which indicates that the opening and closing of the document cover enables automatic detection of the size of the document.

Then, in step S3002, the CPU 111 determines, based on a signal from the opening and closing sensor 401, whether or not the document cover has been opened. If the CPU 111 has determined that the document cover has been opened (Yes in step S3002), the processing proceeds to step S3003. If, on the other hand, the document cover has not been opened, and the size of the document has been input through the operation unit 150 using the screen illustrated in FIG. 15 (No in step S3002), the processing proceeds from step S3002 to step S1404. The CPU 111 displays on the operation unit 150 the screen for receiving the size of the document and receives the size of the document from the user. The user presses one of the document size specifying buttons 742. If the user has pressed one of the document size specifying buttons 742, the pressed document size specifying button 742 enters a selected state. If the user has pressed the OK button 743 with the pressed document size specifying button 742 in the selected state, the CPU 111 stores in the RAM 112 the selected size of the document indicated by the selected document size specifying button 742, and the processing proceeds to step S1403.

After the processing has proceeded from step S3002 to step S3003, then as described above, the CPU 111 performs the processes of steps S3003 to S3005, thereby detecting the size of the document and storing the detected size of the document in the RAM 112. Specifically, in step S3003, the CPU 111 determines whether or not the opening angle of the document cover has reached the predetermined angle (30°). The process of step S3003 is repeated until the opening angle of the document cover reaches the predetermined angle. If the CPU 111 has determined that the opening angle of the document cover has reached the predetermined angle (Yes in step S3003), the processing proceeds from step S3003 to step S3004. In step S3004, the CPU 111 instructs the reader device 200 to irradiate the document with light. After the reader device 200 has irradiated the document with light, the CCD 218 reads the reflected light from the document. In step S3005, the CPU 111 detects the edges of the document from the read image, thereby detecting the size of the document. The CPU 111 stores the detected size of the document in the RAM 112.

According to the third exemplary embodiment, if an instruction to execute a copy job has been given by the pressing of the start key 707 before the size of the document is stored in the RAM 112, it is possible to notify the user that the opening and closing of the document cover enables automatic detection of the size of the document.

### Other Exemplary Embodiments

The above-described exemplary embodiments are not seen to be limiting.

In the above exemplary embodiments, an example has been described where the CCD 218 reads the reflected light from the document irradiated with light, thereby detecting the size of the document. Alternatively, in another exemplary embodiment, the reader unit 200 may detect the size of the document placed on the document platen, using a size detection sensor.

In the above exemplary embodiments, the message 730 in FIG. 10, the message 780 in FIG. 13, and the message 741 in FIG. 15 are displayed on the screen of the operation unit 150. Alternatively, in another exemplary embodiment, a command to display each message on a display unit included in the host computer 610 can be transmitted to the host computer 610, thereby causing the display unit of the host computer 610 to display the message. In yet another exemplary embodiment, the content of each message may be stored in advance in the HDD 160 as audio data, so that when displaying each message, the CPU 111 outputs a sound corresponding to the message through a loudspeaker (not illustrated).

### Other Embodiments

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-139778 filed Jul. 3, 2013, which is hereby incorporated by reference herein in its entirety.

What is claimed is:

1. An image reading apparatus having a first power state and a second power state where power consumption is less than in the first power state, the image reading apparatus comprising:
a document cover configured to be opened and closed to place a document on a document platen;
a determination unit configured to, based on opening and closing of the document cover, determine a size of the document placed on the document platen;
a power control unit configured to cause the image reading apparatus to transition from the second power state to the first power state; and
a notification unit configured to, if the determination unit has not determined the size of the document placed on the document platen after the power control unit has caused the image reading apparatus to transition from the second power state to the first power state, prompt opening and closing of the document cover.

2. The image reading apparatus according to claim 1, wherein, after the notification unit has prompted opening and closing of the document cover, the determination unit, based on the opening and closing of the document cover, determines the size of the document placed on the document platen.

3. The image reading apparatus according to claim 1, wherein, if the document cover is open after the power control unit has caused the image reading apparatus to transition from the second power state to the first power state, the determination unit determines the size of the document placed on the document platen when the document cover is closed.

4. The image reading apparatus according to claim 1, wherein, if the document cover is open after the power control unit has caused the image reading apparatus to transition from the second power state to the first power state, the notification unit does not prompt opening and closing of the document cover.

5. The image reading apparatus according to claim 1, further comprising:
a reception unit configured to receive the size of the document; and
an instruction reception unit configured to receive a reading start instruction to start reading the document,
wherein, if the instruction reception unit has received the reading start instruction after the notification unit has prompted opening and closing of the document cover, and if the determination unit has not determined the size of the document placed on the document platen and the reception unit has not received the size of the document, the notification unit prompts opening and closing of the document cover.

6. The image reading apparatus according to claim 1, wherein according to opening and closing of the document cover, the power control unit causes the image reading apparatus to transition from the second power state to the first power state.

7. The image reading apparatus according to claim 6, further comprising a detection unit configured to detect whether an opening angle of the document cover has reached a predetermined angle,
wherein, if the detection unit detects that the opening angle of the document cover has reached the predetermined angle, the power control unit causes the image reading apparatus to transition from the second power state to the first power state.

8. The image reading apparatus according to claim 1, further comprising an operation unit configured to operate the image reading apparatus,
wherein according to reception of an operation on the operation unit, the power control unit causes the image reading apparatus to transition from the second power state to the first power state.

9. The image reading apparatus according to claim 1, further comprising a job reception unit configured to receive a job from an external apparatus,
wherein when the job reception unit has received the job, the power control unit causes the image reading apparatus to transition from the second power state to the first power state.

10. The image reading apparatus according to claim 1, wherein, if the determination unit determines the size of the document placed on the document platen after the power control unit has caused the image reading apparatus to transition from the second power state to the first power state, the notification unit does not prompt opening and closing of the document cover.

11. The image reading apparatus according to claim 1, wherein the notification unit displays on a display unit a message prompting opening and closing of the document cover.

12. The image reading apparatus according to claim 1, wherein the notification unit provides notification by a sound, thereby prompting opening and closing of the document cover.

13. The image reading apparatus according to claim 1, wherein the determination unit determines, based on reading the document based on opening and closing of the document cover, the size of the document placed on the document platen.

14. The image reading apparatus according to claim 1, wherein the determination unit determines, based on detection of the size of the document by a size detection sensor based on opening and closing of the document cover, the size of the document placed on the document platen.

15. An image reading apparatus having a first power state and a second power state where power consumption is less than in the first power state, the image reading apparatus comprising:
a document cover configured to be opened and closed to place a document on a document platen;
a determination unit configured to, based on an opening and closing of the document cover, determine a size of the document placed on the document platen;
a power control unit configured to cause the image reading apparatus to transition from the second power state to the first power state; and
a notification unit configured to, if the power control unit causes the image reading apparatus to transition from the second power state to the first power state, provide notification that the document cover is not to be closed.

16. The image reading apparatus according to claim 15, wherein the notification unit further provides notification of a time required for the image reading apparatus to transition from the second power state to the first power state.

17. A method of controlling an image reading apparatus having a first power state and a second power state where power consumption is less than in the first power state, and including a document cover configured to be opened and closed to place a document on a document platen, the method comprising:
Determining, based on opening and closing of the document cover, a size of the document placed on the document platen;
causing the image reading apparatus to transition from the second power state to the first power state; and
prompting, if the size of the document placed on the document platen has not been determined after the image reading apparatus has been caused to transition from the second power state to the first power state, opening and closing of the document cover.

18. A method of controlling an image reading apparatus having a first power state and a second power state where power consumption is less than in the first power state, and including a document cover configured to be opened and closed to place a document on a document platen, the method comprising:
determining, based on opening and closing of the document cover, a size of the document placed on the document platen;
causing the image reading apparatus to transition from the second power state to the first power state; and
providing, if the image reading apparatus is caused to transition from the second power state to the first power state, notification that the document cover is not to be closed.

19. A computer-readable storage medium storing computer executable instructions for causing a computer to perform a method of controlling an image reading apparatus having a first power state and a second power state where power consumption is less than in the first power state, and including a document cover configured to be opened and closed to place a document on a document platen, the method comprising:
determining, based on opening and closing of the document cover, a size of the document placed on the document platen;
causing the image reading apparatus to transition from the second power state to the first power state; and
prompting, if the size of the document placed on the document platen has not been determined after the image reading apparatus has been caused to transition from the second power state to the first power state, opening and closing of the document cover.

20. A computer-readable storage medium storing computer executable instructions for causing a computer to perform a method of controlling an image reading apparatus having a first power state and a second power state where power consumption is less than in the first power state, and including a document cover configured to be opened and closed to place a document on a document platen, the method comprising:
determining, based on opening and closing of the document cover, a size of the document placed on the document platen;
causing the image reading apparatus to transition from the second power state to the first power state; and
providing, if the image reading apparatus is caused to transition from the second power state to the first power state, a notification that the document cover is not to be closed.
